(19) United States
(12) Patent Application Publication
(10) Pub. No.: US 2003/0051775 A1
(43) Pub. Date: Mar. 20, 2003

(54) Fe-ni-co alloy for completely flat mask of press-formed type, and completely flat mask and color cathode-ray tube using the same

(76) Inventors: Teruo Suganuma, Hitachi-shi (JP); Norio Yuki, Hitachi-shi (JP); Toshiyuki Ono, Hitachi-shi (JP); Masazumi Mori, Hitachi-shi (JP)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/182,483

(22) PCT Filed: Feb. 8, 2001
(86) PCT No.: PCT/JP01/00892

(30) Foreign Application Priority Data
Feb. 9, 2000 (JP) 2000-031661

(51) Int. Cl. H01F 1/147

(52) U.S. Cl. 148/310

(57) ABSTRACT

A Fe—Ni—Co alloy having improved proof stress and Youngs modulus while retaining low thermal expansivity for press-formed fully flat mask, comprising 30-35% Ni, 2-8% Co, 0.01-0.5% Mn, a total of 0.01-0.8% of one or two or more elements selected from the group consisting of 0.01-0.8% each of Nb, Ta, and Hf, and the balance Fe and unavoidable impurities. The impurities are preferably limited to the ranges of C: ≦0.01%, Si: ≦0.04%, P: ≦0.01%, S: ≦0.01%, and N: ≦0.005%. The alloy is characterized by a Youngs modulus of no less than 120,000 N/mm² after annealing at 900° C. for 30 minutes and by a 0.2% proof stress of no less than 300 N/mm² after annealing at 900° C. for 30 minutes. The invention also provides a press-formed fully flat mask characterized by the use of the Fe—Ni—Co alloy set forth above, and a color picture tube using the fully flat mask of the Fe—Ni—Co alloy.

### FIELD OF THE INVENTION

This invention relates to a Fe—Ni—Co alloy for press-formed type fully flat mask which is formed to a fully flat shape by pressing rather than by stretching on a frame, and also to a fully flat mask of the alloy and a color picture tube using the mask. More particularly, this invention relates to a Fe—Ni—Co alloy which, through the choice of certain additive elements, maintains its own low thermal expansion properties and provides a press-formed fully flat mask with improved proof stress and Youngs modulus as measures of its drop-impact deformation resistance, and further preferably has a lower Ni segregation ratio and also relates to a fully flat mask of the alloy and to a color picture tube using the mask. The term “low thermal expansion properties” as used herein means that the average thermal expansion coefficient at the temperature range of 30-100° C. is no more than 12×10⁻⁷/° C. Also, the term “lower Ni segregation ratio” as used herein means that the measured value of Ni segregation ratio as measured by EPMA (Electron Probe Micro Analyzer) is no more than 1.0%.

### PRIOR ART

A color picture tube displays a given image on its screen as electron beams from electron guns strike a phosphor surface on the inner side of a glass panel. The directions of the electron beams are magnetically controlled by a deflection yoke. In front of the glass panel is located a mechanism for dividing the electron beam into pixels which are directed to desired phosphor dots, the mechanism being known as a mask. Masks for color picture tubes are roughly divided into two types; shadow mask type wherein a mask blank is formed with dots or slots by etching and then formed to the mask shape by pressing, and aperture grille type wherein a mask blank is formed with elongated slits by etching and then stretched vertically with strong forces on a frame. The both types have both respective advantages and disadvantages and are available in the market.

Many attempts have recently been made to develop flat display screens in which the display screens are made flat or planar. One major problem common to the efforts to flatten the display screens of picture tubes is how to make a shadow mask and an aperture grille as flat as possible. While the both types of masks involve their own difficulties, it is generally believed that flattening the surface of a shadow mask by pressing is basically more difficult than in a stretched type such as an aperture grille (refer to NIKKEI ELECTRONICS, Jul. 26, 1999 (No. 748), p.128).

A shadow mask is manufactured by pressing a metal sheet and, unlike the stretched type, it must retain its shape by itself. Basically the shadow mask is unable to retain its shape unless it is spherical in shape. Nevertheless, a fully flat mask should be substantially flat, in contradiction to the above requirement. The only way to clear up this contradiction is to increase the mask strength. The term mask strength as used herein does not mean the generally accepted strength of metal (determined as by a tensile test) but the strength of a mask as assembled in a color picture tube which resists any deformation upon subjection to an impact on the whole picture tube. Specifically, the picture tube is dropped from a given height to see if the mask undergoes any deformation. The development of a mask capable of resisting such impact deformation is required for the perfection of a fully flat tube.

A fully flat tube is required to possess excellent doming characteristics too. The closer the mask shape approaches flatness from the spherical shape, the more acute the angles of incidence of electron beams from electron guns at the four corners of the mask will become. This means that slight deviation of the mask from the place due to thermal expansion can lead to mislanding of the electron beams and cause color mismatching and other problems. In view of the above problem, there has been need for the development of low thermal expansion masks by far the lower in thermal expansion than the existing masks.

The press-formed fully flat mask that has been formed flat by pressing rather than by stretching has the remarkable advantage of needing no a frame for stretching use. The press-formed fully flat mask accordingly makes it necessary to solve the problems involved in its flattening.

While low thermal expansion Fe—Ni alloy (Fe-36% Ni: called Invar) is used for shadow masks, flattening of the picture screen calls for alloys of lower thermal expansion and higher strength properties, as noted above.

As such a lower thermal expansion alloy, a Fe—Ni—Co alloy (Super-Invar) that is Invar with the addition of Co is known. Our experiments have, however, shown that masks made of this existing Fe—Ni—Co alloy do not have sufficient strength for use with fully flat picture tubes. For these reasons there is demand for an alloy that combines the low thermal expansion coefficient of Super-Invar with greater strength necesary for masks.

As another problem, when an Fe—Ni—Co system alloy is worked into a shadow mask, Ni segregations ocurr in its blank, and in the case where the Ni segregations are severe, the segregated portions exhibit etching properties different from those in non-segregated portions. When the mask is etched to form apertures for passing electron beams, steps are formed in the etched apertures associated with the Ni segregation. The mask itself prevents electron beams from uniformly passing through the etched apertures. In a shadow mask having apertures for passing electron beams formed by etching, when light beams are directed through the apertures obliquely from the rear side toward the front side through the apertures (permeation light test) and the front side is wholly observed, any unevenness of the strength of light passed through the apertures appears in stripe pattern in the Ni segregated portions. This is called striped unevenness of permeation caused by Ni segregated portions or “striped unevenness of permeation” for short.

### OBJECT OF THE INVENTION

This invention is aimed at developing a low thermal expansion Fe—Ni—Co alloy for press-formed fully flat mask, with sufficiently increased strength for improved drop-impact deformation resistance and preferably having no Ni segregation, which will be able to keep pace with the future progress of flat color picture tubes.

### SUMMARY OF THE INVENTION

We did various experiments on mask materials to find what properties would be required for increasing the mask strength sufficient to resist the drop-impact deformation. As a result, Youngs modulus and proof stress have been found to be the strongest determinants of mask strength. In brief, a mask material with greater proof stress and Youngs modulus than ordinary materials have been found to give masks resistant to deformation in impact tests on flat picture tubes. Further study has been made on additive elements that would create novel alloys having low thermal expansion coefficients in addition to the strength.

It has finally been found that the addition of an appropriate amount of Co and also a proper amount of Nb, Ta and/or Hf to a Fe—Ni alloy as the base is a useful approach to the problem, and this discovery has now led to this invention. Japanese Patent No. 2902004 (registered Mar. 19, 1999; laid open to the public on Apr. 10, 1991) proposes a solid-solution alloy based on Invar and containing 0.1-5% by weight of Nb, Ta, and/or Ti to enhance the periodic damping ability of an ordinary curved shadow mask so as to prevent color mismatching under the influence of externally applied oscillation (generated by howling) such as sound volume. In a working example of the invention a 39 wt % Ni—Fe alloy is used as Invar alloy. However, the patented invention is not directed to the strengthening of a fully flat mask against its impact deformation as contemplated by this invention. The literature thus fails to furnish any suggestion to this invention.

Taking the etchability and others into consideration, it has also been found favorable to limit the impurity contents of the alloy provided. In particular, the restriction of the N content that forms nitrogen compounds with Nb, Ta, and Hf has been found helpful in enhancing the hot workability and etchability of the resulting alloy.

Thus this invention provides (1) a Fe—Ni—Co system alloy for press-formed type fully flat mask having enhanced proof stress and Youngs modulus while retaining low thermal expansivity, consisting of, in mass percentage (%), from 30 to 35% Ni, from 2 to 8% Co, from 0.01 to 0.5% Mn, a total of from 0.01 to 0.8% of one or two or more elements selected from the group consisting of from 0.01 to 0.8% each of Nb, Ta, and Hf, and the balance Fe and unavoidable impurities, preferably with a total of from 0.01 to 0.5% of one or two or more elements selected from the group consisting of from 0.01 to 0.5% each of Nb, Ta, and Hf for lowering Ni segregation ratio.

It is desirable to limit the impurities to the ranges of C: ≦0.01%, Si: ≦0.04%, P: ≦0.01%, S: ≦0.01%, and N: ≦0.005%.

The alloy according to this invention is characterized by a Youngs modulus of no less than 120,000 N/mm² after annealing at 900° C. for 30 minutes and by a 0.2% proof stress of no less than 300 N/mm² after annealing at 900° C. for 30 minutes.

The invention also provides (2) a press-formed fully flat mask characterized by the use of the Fe—Ni—Co alloy set forth in above, and (3) a color picture tube using the press-formed fully flat mask of the Fe—Ni—Co alloy.

### DETAILED DESCRIPTION OF THE INVENTION

This invention is characterized by the addition of an appropriate amount of Nb, Ta, and/or Hf as an additive element or elements to a low thermal expansion Fe—Ni(—Mn) alloy further lowered in thermal expansion coefficient by the addition of Co so as to improve the proof stress and Youngs modulus and thereby increase the drop-impact deformation resistance of the alloy without increasing its thermal expansion coefficient, while preferably limiting the contents of various impurity elements, i.e., C, Si, P, S, and N.

The grounds on which various limitations are placed to the alloying elements under this invention will now be explained.

(Basic Elements)

Ni:—The Ni content ranges from 30 to 35%, preferably from 31 to 33%, to preclude the generation of an objectionable structure such as martensite and achieve the synergistic effect with Co for enhanced low thermal expansion performance.

Co:—Co reduces thermal expansivity while enhancing proof stress. For these merits a minimum of 2% Co is required, but more than 8% Co affects the strength and deteriorates magnetic properties. In consideration of the Ni content, therefore, Co is added in the range from 2 to 8%, preferably from 4 to 6%, for the purposes of this invention.

Mn:—Mn is added as a deoxidant and is also needed to make S included as an impurity that hampers hot workability, harmless. In order to achieve these effects, 0.01% Mn is necessary. More than 0.5% Mn deteriorates the etching properties and increases the coefficient of thermal expansion. For these reasons the Mn proportion is limited to the range between 0.01 and 0.5%.

(Additional Elements)

Nb, Ta, Hf:—These elements are added in combination with Co to produce synergistic effects so as to obtain desired high proof stress and increased Youngs modulus without increasing thermal expansivity. There is no such effect with less than 0.01% and deteriorated etchability and increased thermal expansion result with more than 0.8%. Thus, when singly used, the element proportion should range from 0.01 to 0.8% and when two or more such elements are used, the total content should be between 0.01 and 0.8% too.

Further, in the production of the alloy of this invention, from the viewpoint of the etching characteristics of mask, it is necessary to pay attention to generation of Ni segregation. It has now found that Nb, Ta, Hf have possible influence to the generation of Ni segregation.

Although detailed mechanism is not make clear, when Nb, Ta, Hf is added, it is supposed that the solidus line temperature and liquidus line temperature in Fe—Ni system alloy are varied so that Ni segregation is liable to occur at the time of casting. Also, the inventors have found that in the case where the Ni segreagtion occur, a Youngs modulus of the alloy lowers. The reason why the Youngs modulus lowers is supposed that the generation of Ni segregation changes the crystal orientation of Fe—Ni sysytem alloy with the change of the Youngs modulus. The Ni segregation is influenced not only by the amounts of Nb, Ta, Hf, but also by the conditions of casting and forging as a matter of cource, but it has found that when the amounts of Nb, Ta, Hf is in the range of 0.01-0.5% singly and in total, Ni segregation ratio is suppressed to no more than 1.0% and the generation of the striped unevenness of permeation caused by Ni segregation can be prevented. For the reason, as preferred contents, when singly used, the element proportion should range from 0.01 to 0.5% and when two or more such elements are used, the total content should be between 0.01 and 0.5% too.

(Impurities)

C:—More than 0.01% C produces carbides to excess and thereby affects etchability unfavorably. Hence the C content should be no more than 0.01%, preferably no more than 0.006%.

Si:—Si has a deoxidizing effect but a Si content in excess of 0.04% seriously affects the etchability. It is therefore limited to 0.04% or less.

P:—Excessive P causes inferior etching. The P content should be no more than 0.01%, preferably no more than 0.005%.

S:—S in excess of 0.01% has a detrimental effect upon hot workability, while forming much sulfide inclusions which, in turn, impairs etchability. Hence the upper limit of 0.01%, preferably 0.005% or less.

N:—N forms compounds with Nb, Ta, and Hf to affect the hot workability and etchability adversely. The N content is no more than 0.005%, preferably no more than 0.003%.

MnS or P segregates, for example, are so ductile that they extend in linear form in the alloy as rolled, and these linear extensions mar the configurations of the surrounding walls of etched apertures in the form of dots or slots. The impurity control is required to avoid the deterioration of etchability.

A shadow mask blank is produced as follows: an alloy material of a desired composition is melt-refined, e.g., in a vacuum induction melting (VIM) furnace, and cast into an ingot. The ingot is forged, hot rolled, and cold rolled. It is further worked by repeated runs of bright annealing and cold rolling. Lastly, the rolled sheet is finally cold rolled to a given thickness in the range from 0.1 to 0.25 mm. The sheet is then slitted into strips of shadow mask blank. The shadow mask blank strips are degreased, coated with photoresist on both sides, exposed with pattern, printed, developed, etched for perforation, and there cut into individual shadow mask blank units.

The shadow mask blank units are annealed in a non-oxidizing atmosphere, such as a reducing atmosphere, (e.g., in hydrogen at 900° C. for 30 minutes) to impart press formability (in a pre-anneal process, this annealing is done to a finally cold rolled material prior to the etching). After passage through a leveler, the blank units are press-formed to the configuration of a fully flat mask each.

Finally, the press-formed fully flat masks are degreased and subjected to a blackening treatment in air or CO/CO₂ gas atmosphere to form a black oxide film on the surface.

The press-formed fully flat mask according to this invention has a nearly completely flat shape, e.g., with an outer surface radius of curvature R of at least 100,000 mm and a flatness in terms of the maximum height of the curved screen surface/effective screen diagonal dimension of no more than 0.1%.

The press-formed fully flat mask of this invention is characterized by a Youngs modulus of no less than 120,000 N/mm² and a 0.2% proof stress of no less than 300 N/mm² exhibited after annealing that is carried out to impart press formability while maintaining an mean coefficient of thermal expansion in the range from 30 to 100° C. no more than 12×10⁻⁷/° C. A Youngs modulus above 120,000 N/mm² and a 0.2% proof stress above 300 N/mm² protect a mask in a fully flat picture tube against deformation in a tube drop test.

The press-formed fully flat mask of this invention can realize a Youngs modulus of no less than 130,000 N/mm² and a 0.2% proof stress of no less than 330 N/mm² and is even capable of attaining a Youngs modulus of no less than 140,000 N/mm² and a 0.2% proof stress of no less than 350 N/mm².

Further, with regard to the etching characteristics, when the Ni segregation ratio is no more than 1.0%, the generation of the defects of the striped unevenness of permeation caused by Ni segregation can be prevented, when the Ni segregation ratio is beyond 1.0%, such defects may possibly occur depending upon the configuration of mask apertures, etching conditions etc. The Ni segregation ratio is defined herein as follows:

ΔNi=Cx−Co

where

ΔNi: Ni segregation ratio (%)

Cx: Ni concentration in Ni segregated portion (%)

Co: Ni concentration in the neighbor of the Ni segregated portion (%)

### WORKING EXAMPLES

### Example 1

Alloy compositions used in working examples of this invention and in comparative examples are shown in Table 1.

TABLE 1

| | Alloy No. | C | N | Si | Mn | P | S | Ni | Co | Nb | Ta | Hf |
|---|---|---|---|---|---|---|---|---|---|---|---|---|
| Example of this | 1 | 0.003 | 0.0030 | <0.01 | 0.25 | 0.003 | 0.002 | 32.2 | 4.82 | 0.26 | <0.001 | <0.001 |
| invention | 2 | 0.004 | 0.0022 | 0.01 | 0.26 | 0.003 | 0.003 | 32.1 | 3.97 | 0.27 | <0.001 | <0.001 |
| | 3 | 0.003 | 0.0018 | 0.01 | 0.24 | 0.002 | 0.002 | 34.0 | 2.21 | 0.26 | <0.001 | <0.001 |
| | 4 | 0.006 | 0.0020 | 0.01 | 0.26 | 0.003 | 0.002 | 31.9 | 4.02 | 0.62 | <0.001 | <0.001 |
| | 5 | 0.003 | 0.0021 | <0.01 | 0.27 | 0.003 | 0.002 | 32.2 | 4.85 | <0.001 | 0.27 | <0.001 |
| | 6 | 0.003 | 0.0012 | 0.02 | 0.25 | 0.004 | 0.003 | 31.7 | 5.01 | <0.001 | <0.001 | 0.23 |
| | 7 | 0.004 | 0.0012 | 0.02 | 0.27 | 0.003 | 0.003 | 31.9 | 5.00 | 0.27 | 0.20 | 0.17 |
| | 8 | 0.003 | 0.0011 | 0.02 | 0.24 | 0.002 | 0.003 | 32.1 | 4.89 | <0.001 | 0.20 | 0.22 |
| | 9 | 0.004 | 0.0012 | <0.01 | 0.30 | 0.003 | 0.004 | 32.3 | 4.88 | 0.25 | 0.18 | <0.001 |
| | 10 | 0.002 | 0.0016 | 0.01 | 0.25 | 0.002 | 0.002 | 31.0 | 4.93 | 0.26 | <0.001 | 0.15 |
| | 11 | 0.015 | 0.0016 | 0.02 | 0.24 | 0.003 | 0.003 | 32.4 | 4.97 | 0.35 | <0.001 | <0.001 |
| | 12 | 0.003 | 0.0060 | 0.01 | 0.31 | 0.002 | 0.004 | 31.7 | 5.09 | 0.30 | <0.001 | <0.001 |
| | 13 | 0.003 | 0.0013 | 0.05 | 0.23 | 0.002 | 0.003 | 31.5 | 5.11 | 0.24 | <0.001 | <0.001 |
| | 14 | 0.004 | 0.0009 | 0.01 | 0.22 | 0.020 | 0.004 | 31.8 | 4.98 | 0.22 | <0.001 | <0.001 |
| | 15 | 0.003 | 0.0022 | 0.01 | 0.21 | 0.002 | 0.013 | 32.5 | 4.99 | 0.33 | <0.001 | <0.001 |
| Comparative | 16 | 0.003 | 0.0023 | 0.01 | 0.26 | 0.003 | 0.002 | 36.0 | <0.01 | <0.001 | <0.001 | <0.001 |
| Example | 17 | 0.003 | 0.0031 | <0.01 | 0.24 | 0.002 | 0.003 | 36.1 | <0.01 | 0.26 | <0.001 | <0.001 |
| | 18 | 0.003 | 0.0011 | 0.01 | 0.21 | 0.002 | 0.004 | 32.3 | 5.02 | <0.001 | <0.001 | <0.001 |
| | 19 | 0.002 | 0.0019 | <0.01 | <0.01 | 0.003 | 0.003 | 32.1 | 4.89 | 0.34 | <0.001 | <0.001 |
| | 20 | 0.003 | 0.0013 | <0.01 | 0.85 | 0.002 | 0.004 | 32.1 | 5.07 | 0.30 | <0.001 | <0.001 |
| | 21 | 0.004 | 0.0009 | 0.02 | 0.27 | 0.003 | 0.003 | 32.4 | 8.5 | 0.35 | <0.001 | <0.001 |
| | 22 | 0.004 | 0.0012 | 0.02 | 0.32 | 0.003 | 0.003 | 32.0 | 5.12 | 0.32 | 0.42 | 0.35 |

10 kg of each of these alloy compositions was melted in a vacuum induction melting (VIM) furnace. After the melting and casting into an ingot, the ingot was forged at 1200° C. and hot rolled at 1200° C. to a sheet 3 mm thick. The sheet was repeatedly cold rolled and bright annealed to obtain a cold rolled sheet about 0.12 mm thick. It was then slitted to strips of shadow mask blank, and the strips were annealed in a reducing atmosphere (in hydrogen at 900° C. for 30 minutes) to impart press formability.

Each sheet material thus annealed was subjected to a tensile test to determine its tensile strength and 0.2% proof stress. It was also tested for its Youngs modulus at room temperature by the bending resonance test in conformity with JIS (Japanese Industrial Standard) R 1605. The method consisted of applying driving forces to the both upper and under surfaces of a test specimen suspended with yarn from a driver side and a sensor side for free bending resonance, producing the maximum amplitude and determining the node of oscillation and then deciding the primary resonance frequency through the sensor, and computing the dynamic elastic modulus from the primary resonance frequency and the mass and dimensions of the test specimen in accordance with a given formula. Further, the mean coefficient of thermal expansion at temperatures in the range from 30 to 100° C. was measured, and the specimen surface was sprayed with a 45 Baume of an aqueous ferric chloride solution at 60° C. and at a pressure of 0.3 MPa, and the etched surface was inspected.

The results are summarized in Table 2. Whether hot tearing occurred or not during hot working is also shown.

TABLE 2

| | | | | | Mean thermal | | |
|---|---|---|---|---|---|---|---|
| | | Tensile | 0.2% proof | Youngs | expansion coefficient | Etched | |
| | Alloy | strength | stress | modulus *1 | at 30° C.˜ | surface | |
| | No. | N/mm² | N/mm² | N/mm² | 100° C. × 10⁻⁷/° C. | condition *2 | Hot tearing |
| Example of this | 1 | 491 | 334 | 134200 | 5.0 | ◯ | No |
| invention | 2 | 485 | 330 | 133100 | 10.0 | ◯ | No |
| | 3 | 490 | 335 | 138900 | 11.8 | ◯ | No |
| | 4 | 495 | 341 | 136100 | 11.0 | ◯ | No |
| | 5 | 500 | 350 | 135500 | 5.8 | ◯ | No |
| | 6 | 488 | 332 | 134500 | 6.0 | ◯ | No |
| | 7 | 502 | 348 | 143000 | 10.5 | ◯ | No |
| | 8 | 510 | 352 | 145000 | 7.6 | ◯ | No |
| | 9 | 499 | 352 | 141000 | 8.2 | ◯ | No |
| | 10 | 502 | 356 | 142000 | 8.0 | ◯ | No |
| | 11 | 487 | 330 | 136100 | 5.2 | X | No |
| | 12 | 496 | 341 | 139000 | 7.0 | X | No |
| | 13 | 490 | 332 | 134300 | 8.6 | X | No |
| | 14 | 500 | 345 | 141000 | 8.3 | X | No |
| | 15 | 490 | 331 | 136700 | 8.5 | X | Yes |
| Comparative | 16 | 446 | 272 | 125300 | 15.0 | ◯ | No |
| Example | 17 | 485 | 332 | 130900 | 16.1 | ◯ | No |
| | 18 | 450 | 285 | 118100 | 4.7 | ◯ | No |
| | 19 | 496 | 338 | 135400 | 6.1 | ◯ | Yes |
| | 20 | 498 | 335 | 135300 | 13.4 | ◯ | No |
| | 21 | 515 | 361 | 141500 | 20.5 | ◯ | No |
| | 22 | 520 | 367 | 142300 | 17.2 | X | No |

*1 Measured by the vibration method.
*2 ◯ = Good.
X = Minute surface irregularities and etched marks with inclusions and others.

Alloy Nos. 1 through 15 of this invention well realized the targets of Youngs modulus and 0.2% proof stress i.e., Youngs modulus of no less than 120,000 N/mm² and 0.2% proof stress of no less than 300 N/mm², without increasing the coefficients of thermal expansion beyond the level considered permissible (12×10⁻⁷/° C.). In particular, Alloy Nos. 8 to 10 exhibited Youngs modulus of more than 140,000 N/mm² and, at the same time, 0.2% proof stress of more than 350 N/mm². With the Mn and impurity contents well within the specified ranges, they showed good etched surfaces. No hot tearing occurred except that micro hot tearing is generated in Sample No. 15 with S content of as high as 0.013%.

Further, Alloys Nos. 11 to 15 that contained impurity elements C, N, Si, P, and S in more than specified claimed ranges all gave unfavorable etched surfaces with minute irregularities and etched marks with impurities.

In contrast with these, Alloy Nos. 16 and 17 without the Co addition had high mean thermal expansion coefficients, No. 16 being inferior in strength properties too.

Alloy No. 18 that contained Co but not Nb, Ta, or Hf showed very poor strength properties.

Alloy No. 19 developed hot tearing because of its low Mn content.

Alloy No. 20 having the Mn content of more than 0.5% resulted in a high mean coefficient of thermal expansion.

Alloy No. 21, with Co in excess of 8%, showed a very high mean thermal expansion coefficient.

Alloy No. 22 that contained Nb, Ta, and Hf in a total amount of more than 0.8% also showed very high thermal expansivity.

By the way, with regard to Ni segregation ratio, segregated stripe was observed which was made visually developed by mirror-polishing a cross section of each specimen and immersion-etching each in a 45 Baumé of an aqueous ferric chloride solution diluted tenfold with water for 30 seconds. With the alloy No. 22 in Table 2, the strongest segregation stripe was observed. The Ni segregation ratio of this segregation stripe as measured was 0.96%.

### Example 2

Investigation was done on an industrial scale. 6000 kg of each of these alloy compositions in Table 3 was melted in a vacuum induction melting (VIM) furnace. After the melting and casting into an ingot, the ingot was forged at 1200° C. and hot rolled at 1200° C. to a sheet 3 mm thick. The sheet was repeatedly cold rolled and bright annealed to obtain a cold rolled sheet about 0.12 mm thick. It was then slitted to strips of shadow mask blank, and the strips were annealed in a reducing atmosphere (in hydrogen at 825° C. for 15 minutes) to impart press formability.

The annealing condition of 825° C.×15 minutes was set at a lower temperature than in Example 1 to obtain a higher 0.2% proof stress.

TABLE 3

| Alloy No. | C | N | Si | Mn | P | S | Ni | Co | Nb | Ta | Hf |
|---|---|---|---|---|---|---|---|---|---|---|---|
| 23 | 0.006 | 0.0013 | 0.02 | 0.24 | 0.002 | 0.003 | 32.2 | 5.02 | 0.48 | <0.001 | <0.001 |
| 24 | 0.003 | 0.0012 | 0.02 | 0.25 | 0.004 | 0.003 | 31.7 | 5.01 | <0.001 | <0.001 | 0.23 |
| 25 | 0.003 | 0.0019 | 0.01 | 0.22 | 0.003 | 0.002 | 31.8 | 5.01 | 0.15 | 0.12 | 0.14 |
| 26 | 0.004 | 0.0012 | 0.02 | 0.24 | 0.002 | 0.002 | 32.1 | 5.00 | 0.11 | <0.001 | <0.001 |
| 27 | 0.003 | 0.0009 | 0.01 | 0.23 | 0.002 | 0.002 | 31.9 | 4.99 | <0.001 | 0.05 | <0.001 |
| 28 | 0.003 | 0.0009 | 0.01 | 0.23 | 0.002 | 0.002 | 32.1 | 5.03 | 0.04 | 0.04 | 0.06 |
| 29 | 0.004 | 0.0012 | 0.02 | 0.24 | 0.002 | 0.019 | 32.1 | 4.95 | 0.32 | <0.001 | <0.001 |
| 30 | 0.003 | 0.0031 | <0.01 | 0.24 | 0.002 | 0.003 | 34.1 | 2.54 | <0.001 | <0.001 | <0.001 |
| 31 | 0.004 | 0.0022 | 0.01 | 0.23 | 0.003 | 0.002 | 31.7 | 4.99 | 0.61 | <0.001 | <0.001 |
| 32 | 0.005 | 0.0012 | 0.01 | 0.24 | 0.002 | 0.002 | 32.1 | 4.97 | <0.001 | 0.56 | <0.001 |
| 33 | 0.003 | 0.0011 | 0.01 | 0.22 | 0.002 | 0.002 | 31.5 | 5.01 | <0.001 | 0.23 | 0.46 |

Each sheet material thus annealed was subjected to a tensile test to determine its tensile strength and 0.2% proof stress. It was also measured for its Youngs modulus and mean thermal expansion coefficient. All tests were done as in Example 1. Investigations were made as to etchability (whether or not minute etched marks with inclusion and others occurred) and Ni segregation. It was also confirmed whether any striped unevenness of permeation were generated or not.

With regard to the segregation stripes, the segregated stripes in cross section of each sample were observed with a microscope as in Example 1. Three strongest segregation stripes were selected and Ni segregation ratios of respective stripes were measured with EPMA and the maximum value of three measured results was indicated.

As of the striped unevenness of permeation caused by Ni segregation, after forming a resist mask having a number of round openings, 80 μm in diameter on one side of a each sample and a resist mask having a corresponding number of rounf openings, 180 μm in diameter on the other side, and spray-etching the apertures for passing electron beams with a 45 Baumé of an aqueous ferric chloride solution at 60° C. under a pressure of 0.3 MPa, light beams are passed obliquely from behind toward the front. Whether or not striped unevenness of permeation occurred was confirmed.

These results were presented in Table 4.

TABLE 4

| | | | | Mean thermal | Ni | etched surface condition | |
|---|---|---|---|---|---|---|---|
| | Tensile | 0.2% proof | Youngs | expansion coefficient | segregation | | whether minute etched |
| | Strength | stress | modulus *1 | at 30° C.˜ | ratio | striped | marks with inclusion and |
| Alloy No. | MPa | MPa | MPa | 100° C. × 10⁻⁷/° C. | % *2 | unevenness | others are present |
| 23 | 514 | 357 | 141200 | 5.8 | 0.92 | No | No |
| 24 | 498 | 340 | 142800 | 5.3 | 0.81 | No | No |
| 25 | 509 | 352 | 141300 | 6.9 | 0.80 | No | No |
| 26 | 485 | 328 | 136500 | 4.9 | 0.69 | No | No |
| 27 | 477 | 312 | 131300 | 4.8 | 0.67 | No | No |
| 28 | 488 | 330 | 135700 | 5.3 | 0.73 | No | No |
| 29 | 498 | 340 | 142400 | 5.2 | 0.75 | No | No |
| 30 | 448 | 288 | 119500 | 8.2 | 0.66 | No | Yes |
| 31 | 497 | 340 | 133500 | 7.5 | 1.12 | Yes | No |
| 32 | 512 | 355 | 135200 | 7.2 | 1.05 | Yes | No |
| 33 | 515 | 357 | 130500 | 7.8 | 1.15 | Yes | No |

*1 Measured by the vibration method
*2 Max. value of three measured values

Alloy Nos. 23 through 29 of this invention well realized the targets of Youngs modulus and 0.2% proof stress i.e., Youngs modulus of no less than 130,000 N/mm² and 0.2% proof stress of no less than 300 N/mm², without increasing the coefficients of thermal expansion beyond the level considered permissible (12×10⁻⁷/° C.). Ni segregation ratios were no more than 1% and so realized good etchability. No unevenness in stripe forms of light beams passed through apertures was observed. In particular, Alloy Nos. 23, 24, 25 and 29 wherein Nb, Ta, Hf were contained in the total contents of 0.2 to 0.5% exhibited Youngs modulus of more than 140,000 N/mm² and 0.2% proof stress of more than 330 MPa, and at the same time exhibited Ni segregation ratio of no more than 1%.

In contrast with these, Alloy No. 30 with total content of Nb, Ta, Hf of less than 0.01% exhibited lower Youngs modulus and 0.2% proof stress.

Alloy Nos. 31 to 33 wherein the total contents of Nb, Ta, Hf are beyond 0.5% showed high Ni segregation ratios beyond 1.0%. Unevenness in stripe forms of light beams passed through apertures was also observed. Youngs modulus of these alloys were in the range of 130000 to 140000 MPa over the target value, but were lower than those of Alloy Nos. 23, 24, 25 and 29 having the total contents of Nb, Ta, Hf of 0.2 to 0.5%.

Therefore, in the applications where great importance is particularly attached to Ni segregation, it is recommended to control the contents of Nb, Ta, Hf singly and in total to no more than 0.5%, it is noted that these Ni segregation may be prevented or reduced also by closely and carefully controlling the production process condition including casting and forging conditions.

(Advantages of the Invention)

As has been described above, this invention adds Co to a Fe—Ni alloy containing an adequate concentration of Ni to make up for the deficient proof stress while maintaining low thermal expansivity and also to enhance the Youngs modulus, with the aid of Nb, Ta, and/or Hf by a synergistic effect with Co. It will be understood from the foregoing that these elements do not have an adverse effect upon the thermal expansivity and impart optimum properties to the mask material for fully flat picture tubes.

Through the control of impurity elements including N, the deterioration of hot workability and etchability can be avoided.

Also, the Ni segregation problem has solved.

Thus a desirably press-formed fully flat mask which is free from color mismatching and is resistant to deformation on handling to suit flat color picture tubes of the future has now been obtained.

What is claimed is:

1. A Fe—Ni—Co system alloy for press-formed type fully flat mask having improved proof stress and Youngs modulus while retaining low thermal expansivity, consisting of, in mass percentage (%), from 30 to 35% Ni, from 2 to 8% Co, from 0.01 to 0.5% Mn, a total of from 0.01 to 0.8% of one or two or more elements selected from the group consisting of from 0.01 to 0.8% each of Nb, Ta, and Hf, and the balance Fe and unavoidable impurities.

2. A Fe—Ni—Co system alloy for press-formed type fully flat mask having improved proof stress and Youngs modulus while retaining low thermal expansivity, said alloy further having lower Ni segregation ratio, consisting of, in mass percentage (%), from 30 to 35% Ni, from 2 to 8% Co, from 0.01 to 0.5% Mn, a total of from 0.01 to 0.5% of one or two or more elements selected from the group consisting of from 0.01 to 0.5% each of Nb, Ta, and Hf, and the balance Fe and unavoidable impurities.

3. A Fe—Ni—Co system alloy according to claim 1 or 2 wherein the impurity contents are restricted to the ranges of
C: ≦0.01%, Si: ≦0.04%, P: ≦0.01%, S: ≦0.01%, and N: ≦0.005%.

4. A Fe—Ni—Co system alloy according to claim 1 or 2 or 3 wherein the Youngs modulus is no less than 120,000 N/mm² after annealing at 900° C. for 30 minutes.

5. A Fe—Ni—Co system alloy according to claim 1 or 2 or 3 wherein the (0.2%) proof stress is no less than 300 N/mm² after annealing at 900° C. for 30 minutes.

6. A press-formed type fully flat mask made of the Fe—Ni—Co system alloy as described in any of claims 1 to 5.

7. A color picture tube using the press-formed type fully flat mask of the Fe—Ni—Co system alloy according to claim 6.
